(19) United States
(12) Patent Application Publication
(10) Pub. No.: US 2017/0024860 A1
(43) Pub. Date: Jan. 26, 2017

(54) METHOD AND DEVICE FOR ADAPTIVE SPATIAL-DOMAIN VIDEO DENOISING

(71) Applicants: LE HOLDINGS (BEIJING) CO., LTD., Beijing (CN); LECLOUD COMPUTING CO., LTD., Beijing (CN)

(72) Inventors: Yang LIU, Beijing (CN); Maosheng BAI, Beijing (CN); Xingyu LI, Beijing (CN); Wei WEI, Beijing (CN); Yangang CAI, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/242,286

(22) Filed: Aug. 19, 2016

Related U.S. Application Data
(63) Continuation of application No. PCT/CN2016/083056, filed on May 23, 2016.

(30) Foreign Application Priority Data
Jul. 24, 2015 (CN) 201510440941.1

(51) Int. Cl. G06T 5/00; G06K 9/42; G06K 9/00

(52) U.S. Cl. CPC G06T 5/002; G06K 9/00744; G06K 9/42; G06T 2207/10016; G06T 2207/20012

(57) ABSTRACT

The embodiments of the present invention provide a method for adaptive spatial-domain video denoising, including: acquiring the pixel value of each pixel at the same positions of a current frame and a previous adjacent frame thereof so as to calculate the noise intensity of the current pixel; and acquiring the pixel values of adjacent pixels in the up, down, left and right sides of the current pixel in a current frame respectively, calculating the denoising weights of the current pixel and the adjacent pixels in the up, down, left and right sides according to the noise intensity, the pixel value of the current pixel and the pixel values of the adjacent pixels in the up, down, left and right sides, and using a value acquired through weighted average to replace the pixel value of the current pixel so as to maximally reserve frame details while implementing the adaptive spatial-domain denoising of the current pixel.

### CROSS-REFERENCE

This application is a continuation of International Application no. PCT/CN2016/083056, filed on May 23, 2016, which claims priority to Chinese Patent Application 201510440941.1, titled “Method and Device for Adaptive Spatial-domain Video Denoising,” filed on Jul. 24, 2015, the entire contents of which are incorporated herein by reference.

### TECHNICAL FIELD

The present application relates to the field of video technologies, and more particularly, to a method and a device for adaptive spatial-domain video denoising.

### BACKGROUND

With the rapid development of digital video applications, various noises are inevitably introduced during the process of video collection, transmission, coding and decoding in a digital video system, while the existence of noises not only severely affects the subjective visual quality of the videos, but also affects the subsequent processing of the videos, for example, coding, transcoding, or the like. Therefore, with the wide application of the digital videos, an effective video denoising method is urgently needed.

The video denoising methods may substantially include such types as time-domain denoising, spatial-domain denoising, time-domain and spatial-domain denoising. Most denoising methods at present need to set the denoising intensity in advance and then perform denoising on each pixel of the video according to the set same denoising intensity. Such processing can achieve the denoising effects on a video having noises, while for a voice with changes or without noises, the details in a video frame processed will be greatly lost. Therefore, it is very necessary to find a denoising method capable of automatically regulating the denoising intensity according to the noise intensity of the video frame.

The present invention provides an adaptive spatial-domain video denoising method capable of automatically setting the denoising intensity according to the noise intensity of each pixel in the video frame to finish denoising. The method avoids detail losses caused to the pixel videos without noises while assuring the effective denoising of the noise pixels.

### SUMMARY

The embodiments of the present application provides a method and a device for adaptive spatial-domain video denoising, for dynamically regulating the denoising intensity according to the noise intensity of each pixel in the video frame to finish denoising.

In order to implement the foregoing objects, the embodiments of the present application employ the following technical solutions.

According to a first aspect, it provides a method for adaptive spatial-domain video denoising, including:

acquiring the pixel values of all the pixels at the same positions of a current frame and a previous adjacent frame thereof respectively and normalizing the pixel values acquired;

calculating the noise intensity of a current pixel according to the pixel value of the current pixel in the current frame and the pixel value of the pixel in the previous adjacent frame at the same position with the current pixel after normalizing;

acquiring the pixel values of adjacent pixels in the up, down, left and right sides of the current pixel in the current frame respectively; and performing adaptive spatial-domain denoising on the current pixel according to the noise intensity, the pixel value of the current pixel and the pixel values of the adjacent pixels in the up, down, left and right sides.

According to a second aspect, it provides a computer-readable recording medium recording a program configured to conduct the above described method.

According to a third, it provides a device for adaptive spatial-domain video denoising, including:

a pixel value acquisition module configured to acquire the pixel value of each pixel at the same positions of a current frame and a previous adjacent frame thereof respectively, and further configured to acquire the pixel values of adjacent pixels in the up, down, left and right sides of the current pixel in the current frame respectively;

a normalization processing module configured to normalize the pixel value of each pixel at the same positions of the current frame and the previous adjacent frame acquired;

a noise intensity calculation module configured to normalize the pixel value of each pixel at the same positions of the current frame and the previous adjacent frame acquired by the pixel value acquisition module, and further configured to calculate the noise intensity of the current pixel according to the pixel value of the current pixel in the current frame and the pixel value of the pixel in the previous adjacent frame at the same position with the current pixel; and

an adaptive spatial-domain denoising module configured to perform adaptive spatial-domain denoising on the current pixel according to the noise intensity, the pixel value of the current pixel and the pixel values of the adjacent pixels in the up, down, left and right sides.

### BRIEF DESCRIPTION OF THE DRAWINGS

In order to explain the technical solutions in the embodiments of the present application or in the prior art more clearly, the drawings used in the descriptions of the embodiments or the prior art will be simply introduced hereinafter. It is apparent that the drawings described hereinafter are merely some embodiments of the present invention, and those skilled in the art may also obtain other drawings according to these drawings without going through creative work.

FIG. 1 is a flow chart of a first present application;

FIG. 2 is a schematic diagram illustrating pixels at the same positions of a previous adjacent frame and the current frame of the present application;

FIG. 3 is a flow chart of a second present application;

FIG. 4 is a schematic diagram illustrating a noise intensity function corresponding to difference of the pixel value of pixels at the same positions between two adjacent frames of the present application;

FIG. 5 is a flow chart of a third present application;

FIG. 6 is a schematic diagram illustrating the current pixel and pixels in the up, down, left and right sides of the current pixel of the present application; and

FIG. 7 is a structural diagram illustrating a device according to a fourth embodiment of the present application.

### PREFERRED EMBODIMENTS

To make the objects, technical solutions and advantages of the embodiments of the present application more clearly, the technical solutions of the present application will be clearly and completely described hereinafter with reference to the embodiments and drawings of the present application. Apparently, the embodiments described are merely partial embodiments of the present invention, rather than all embodiments. Other embodiments derived by those having ordinary skills in the art on the basis of the embodiments of the present invention without going through creative efforts shall all fall within the protection scope of the present invention.

### First Embodiment

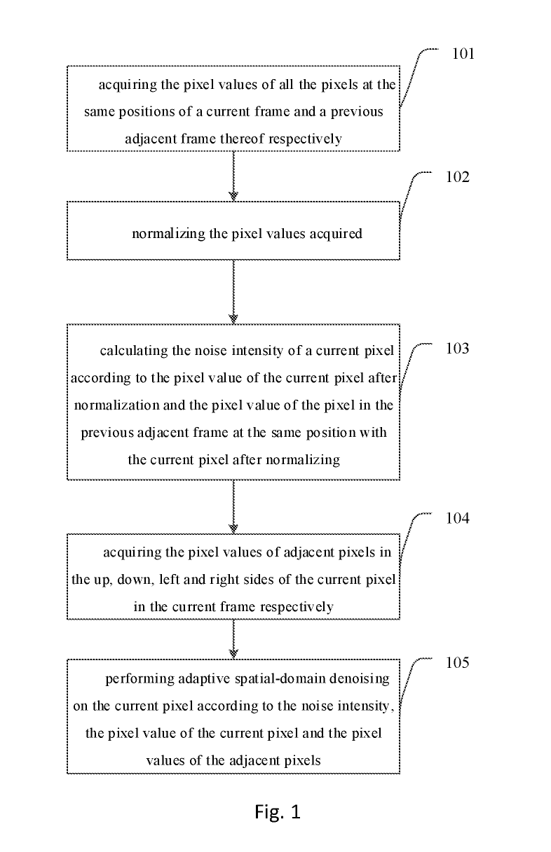

As shown in FIG. 1, a method for adaptive spatial-domain video denoising according to the present invention mainly includes the following steps.

In step 101: the pixel values of all the pixels at the same positions of a current frame and a previous adjacent frame thereof are acquired respectively.

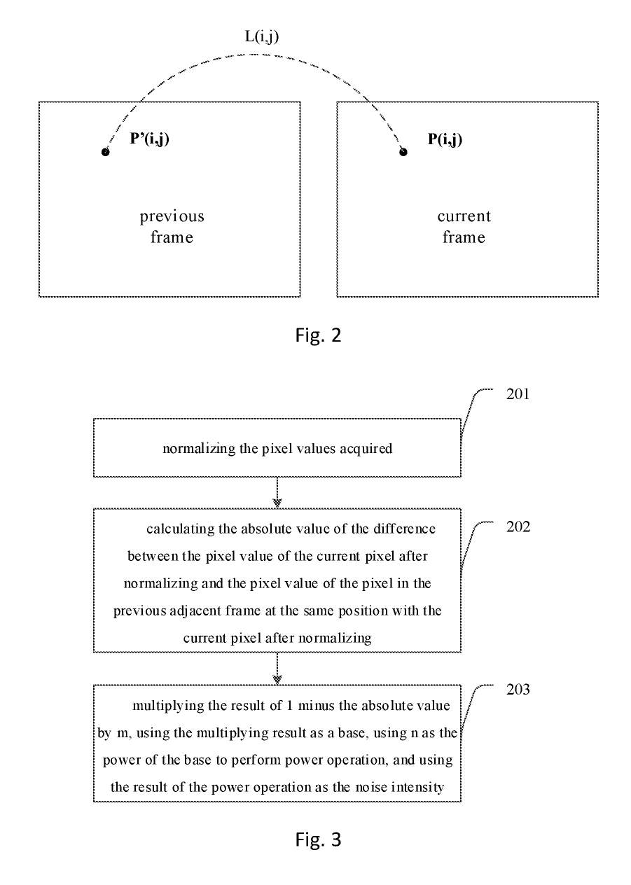

As shown in FIG. 2, the pixel in the current frame is P(i,j), the pixel at the same position of the previous adjacent frame is P′ (i,j), wherein i,j are coordinates in the frame where the pixels locate and the acquiring in the step are traversely performed on all the pixels in the video frame.

In step 102: the pixel value of each pixel at the same positions of the current frame and the previous adjacent frame acquired are normalized.

In step 103: the noise intensity of a current pixel is calculated according to the pixel value of the current pixel and the pixel value of the pixel in the previous adjacent frame at the same position with the current pixel after normalizing.

In step 104: the pixel values of adjacent pixels in the up, down, left and right sides of the current pixel in the current frame are acquired respectively.

In step 105: adaptive spatial-domain denoising is performed on the current pixel according to the noise intensity, the pixel value of the current pixel and the pixel values of the adjacent pixels in the up, down, left and right sides.

### Second Embodiment

As shown in FIG. 3, the calculating the noise intensity of the current pixel according to the pixel value of the current pixel in the current frame after normalizing and the pixel value of the pixel in the previous adjacent frame at the same position with the current pixel after normalizing further includes the following steps.

In step 201: the pixel values acquired are normalized.

Normalization is a simplified calculation manner, which changes a dimensional expression into a dimensionless expression and become a scalar upon transformation. In the step, the pixel value P(i, j) acquired is normalized, so that 0≦P≦1.

A specific formula for the normalization calculation is as follows:

$$V ( i , j ) = \frac{P ( i , j )}{255 - 0} \qquad formula 1$$

In the formula 1, V(i, j) is a normalization calculation result, P(i, j) is the pixel value of each of the current pixel, 255 is the maximum pixel value, and 0 is the minimum pixel value.

In step 202: the absolute value of the difference between the pixel value of the current pixel after normalizing and the pixel value of the pixel in the previous adjacent frame at the same position with the current pixel after normalizing.

The appearance of noises in the video is random, i.e. the position of the noises appeared between two adjacent video frames is random. In a case of no noises and no frame switching, the pixel value of each pixel at the same positions of the two adjacent frames has little change. Therefore, a certain corresponding relation exists between the absolute value of the difference of the pixel values at the same positions of the two adjacent video frames and the noise intensity.

In step 203: a following formula L(i, j)=(m*(1−|V′(i, j)−V(i, j)|))ⁿ*|V′(i, j)−V(i, j)| is used to calculate the noise intensity of the current pixel, wherein V(i, j) is the pixel value of the current pixel after normalizing, V′(i, j) is the pixel value of the pixel in the previous adjacent frame at the same position with the current pixel after normalizing, and m and n are constants, both of which are empirical values and preset according to the denoising intensity.

The noise intensity calculation method is as shown in formula 2:

L(i, j)=(m*(1−|V′(i, j)−V(i, j)|))ⁿ*|V′(i, j)−V(i, j)| formula 2

In the formula 2, L(i, j) is the noise intensity, V′ and V represent two two-dimensional matrixes, V′ is the normalized pixel value of all the pixels in the previous video frame, V is the normalized pixel value of all the pixels in the current frame, wherein, m and n are constants, both of which are empirical values and regulated according to the denoising intensity. Upon test and research, the adaptive denoising result is optimal when the value of n ranges from 0.80 to 0.99.

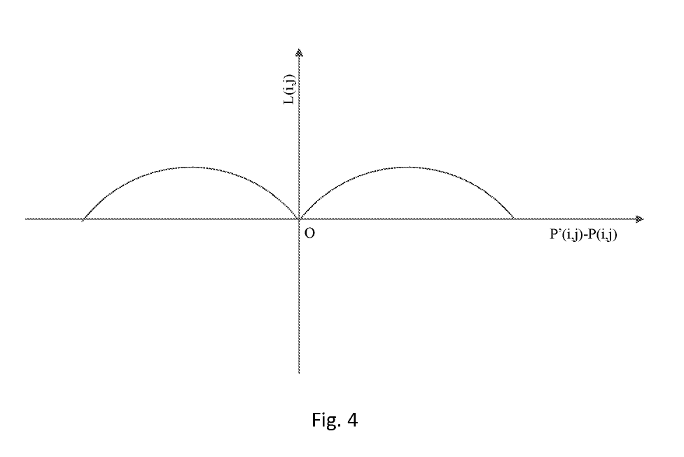

As shown in FIG. 4, the absolute value of the difference of the pixel values and the noise intensity are in Gaussian distributions approximately. When the absolute value of the difference of the pixel values is less than a first threshold or the absolute value of the difference of the pixel values is greater than a second threshold, the noise intensity calculated out through the formula 1 is 0 approximately, which indicates that the current pixel has no noise and there is no frame switching between the current video frame and the previous video frame, wherein the first threshold value is less than the second threshold.

### Third Embodiment

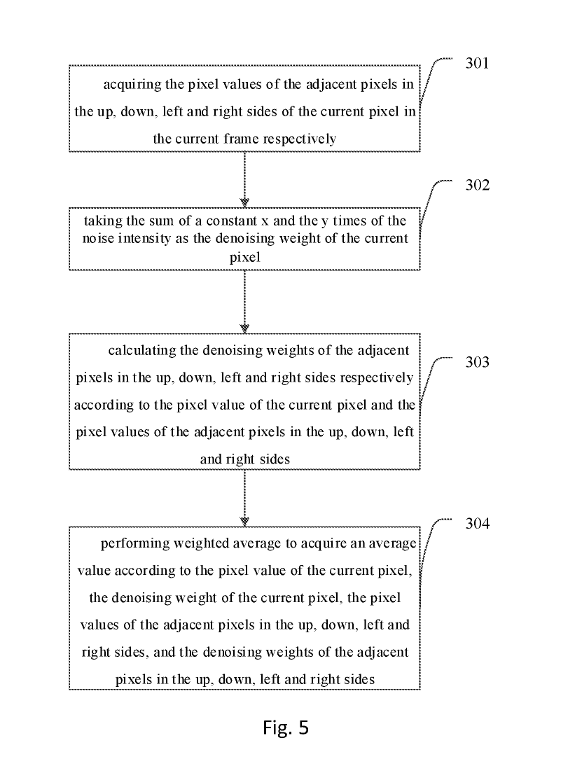

As shown in FIG. 5, the acquiring the pixel values of the adjacent pixels in the up, down, left and right sides of the current pixel in the current frame respectively, and the performing the adaptive spatial-domain denoising on the current pixel according to the noise intensity, the pixel value of the current pixel and the pixel values of the adjacent pixels in the up, down, left and right sides further include the following steps.

In step 301: the pixel values of the adjacent pixels in the up, down, left and right sides of the current pixel in the current frame are acquired respectively.

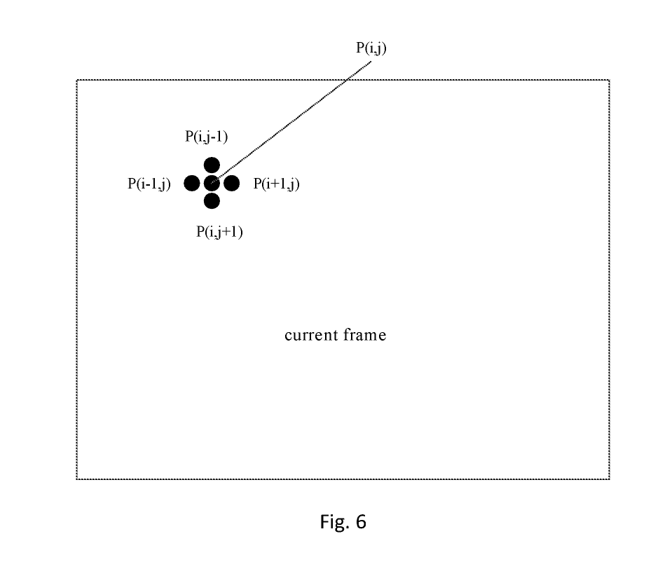

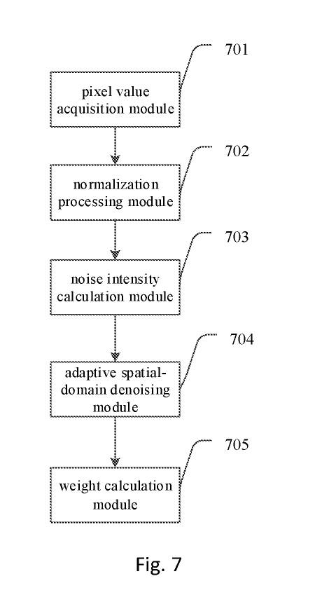

As shown in FIG. 6, the pixel value of the current pixel is P(i, j), the pixel value of the pixel in the left side is P(i−1, j), the pixel value of the pixel in the right side is P(i+1, j), the pixel value of the pixel in the up side is P(i, j−1), and the pixel value of the pixel in the down side is P(i, j+1).

In step 302: the denoising weight of the current pixel is calculated according to a formula Wₘ=x+y*L(i, j), wherein x and y are empirical values and are regulated according to the noise intensity of the current pixel.

The denoising weight calculation method of the current pixel is as shown in formula 3:

wₘ=x+y*L(i, j) formula 3

In formula 3, wₘ is the denoising weight of the current pixel, x and y are empirical values and are set according to the noise intensity. When the noise intensity L(i, j) is greater than a specific threshold, the denoising weight of the current pixel is decreased by decreasing x and y, thus decreasing the denoising weight of the noise pixel to achieve preferable denoising effects.

In step 303: the denoising weights of the adjacent pixels in the up, down, left and right sides are calculated respectively according to the pixel value of the current pixel and the pixel values of the adjacent pixels in the up, down, left and right sides.

The denoising weights of the adjacent pixels in the up, down, left and right sides are calculated using a formula 4, wherein the formula is shown as follows:

$${f}_{x} = {e}^{\{ \frac{- {x}^{2}}{2 {σ}^{2}} \}} \qquad formula 4$$

The formula 4 is the deformation of a normal distribution, fₓ is a normal distribution function, x is a random variable, and σ is the standard deviation of the normal distribution. In the present invention, the differences between the pixel value of the current pixel and the pixel values of the adjacent pixels in the up, down, left and right sides are used as a random variable x, and calculation is performed according to a present standard deviation σ. The specific calculation method is as shown in a following formula:

$${x}_{l} = \{ P ( i - 1 , j ) - P ( i , j ) \\ {x}_{r} = P ( i + 1 , j ) - P ( i , j ) \\ {x}_{t} = P ( i , j - 1 ) - P ( i , j ) \\ {x}_{b} = P ( i , j + 1 ) - P ( i , j ) \\ {w}_{l} = {e}^{\{ \frac{- {x}_{l}^{2}}{2 {σ}^{2}} \}} = {e}^{\{ \frac{- {[ P ( i - 1 , j ) - P ( i , j ) ]}^{2}}{2 {σ}^{2}} \}} \\ {w}_{r} = {e}^{\{ \frac{- {x}_{r}^{2}}{2 {σ}^{2}} \}} = {e}^{\{ \frac{- {[ P ( i + 1 , j ) - P ( i , j ) ]}^{2}}{2 {σ}^{2}} \}} \\ {w}_{t} = {e}^{\{ \frac{- {x}_{t}^{2}}{2 {σ}^{2}} \}} = {e}^{\{ \frac{- {[ P ( i , j - 1 ) - P ( i , j ) ]}^{2}}{2 {σ}^{2}} \}} \\ {w}_{b} = {e}^{\{ \frac{- {x}_{b}^{2}}{2 {σ}^{2}} \}} = {e}^{\{ \frac{- {[ P ( i , j + 1 ) - P ( i , j ) ]}^{2}}{2 {σ}^{2}} \}} \qquad formula 5$$

In formula 5 xₗ, xᵣ, xₜ, x_{b} are the differences between the pixel value of the current pixel and the pixel values of the adjacent pixels in the up, down, left and right sides respectively, wₗ is the denoising weight of the adjacent pixel in the left side, wᵣ is the denoising weight of the adjacent pixel in the right side, wₜ is the denoising weight of the adjacent pixel in the up side, w_{b} is the denoising weight of the adjacent pixel in the down side, σ is a preset standard deviation, and σ=15 usually.

In step 304: weighted average is performed to acquire an average value according to the pixel value of the current pixel, the denoising weight of the current pixel, the pixel values of the adjacent pixels in the up, down, left and right sides, and the denoising weights of the adjacent pixels in the up, down, left and right sides, and the average value is used to replace the pixel value of the current pixel.

The denoising weight of the current pixel multiplied by the pixel value of the current pixel plus the denoising weights of the adjacent pixels in the up, down, left and right sides multiplied by the pixel values of the adjacent pixels in the up, down, left and right sides is used as a weighted summation result, the sum of the denoising weight of the current pixel and the denoising weights of the adjacent pixels in the up, down, left and right sides is used as the base number of the weighted average, and a result of the weighted average obtained by dividing the weighted summation result by the base number is used to replace the pixel value of the current pixel.

The specific calculation for the weighted average is as shown in a following formula:

N(i, j)=[wₘ*P(i, j)+wₗ*P(i−1, j)+wᵣ*P(i+1, j)+wₜ*P(i, j−1) +w_{b}* P(i, j+1)]/(wₘ+wₗ+wᵣ+wₜ+w_{b}) formula 6

In formula 6, N(i, j) is an average value acquired by the weighted average, and N(i, j) is used to replace the pixel value of the current pixel. This step is traversely performed on all the noise pixels in each of the current frame, and will not be elaborated herein.

The present invention can implement adaptive regulation of the denoising intensity through calculating the noise intensity of the video frame, thus being capable of preserving details in the frames of videos with noise intensity change or without noises, and being more beneficial for improving the video quality and the viewing experience of viewers.

### Fourth Embodiment

The present invention relates to a device adaptive spatial-domain video denoising, including:

The pixel value acquisition module 701 is configured to acquire the pixel value of each pixel at the same positions of a current frame and a previous adjacent frame thereof respectively, and is also configured to acquire the pixel values of adjacent pixels in the up, down, left and right sides of the current pixel in the current frame respectively;

the normalization processing module 702 is configured to normalize the pixel value of each pixel at the same positions of the current frame and the previous adjacent frame acquired;

the noise intensity calculation module 703 is configured to calculate the noise intensity of a current pixel according to the pixel value of the current pixel in the current frame and the pixel value of the pixel in the previous adjacent frame at the same position with the current pixel after normalizing; and

the adaptive spatial-domain denoising module 704 is configured to perform adaptive spatial-domain denoising on the current pixel according to the noise intensity, the pixel value of the current pixel and the pixel values of the adjacent pixels in the up, down, left and right sides.

The noise intensity calculation module 703 is further configured to calculate the absolute value of the difference between the pixel value of the current pixel after normalizing and the pixel value of the pixel in the previous adjacent frame at the same position with the current pixel after normalizing, and the noise intensity of the current pixel is calculated according to a following formula L(i, j)=(m*(1−|V′(i, j)−V(i, j)|))ⁿ*|V′(i, j)−V(i, j)|, wherein V(i, j) is the pixel value of the current pixel after normalizing, V′(i, j) is the pixel value of the pixel in the previous adjacent frame at the same position with the current pixel after normalizing, and m and n are constants, both of which are empirical values and preset according to the denoising intensity.

The adaptive spatial-domain denoising module 704 is further configured to perform weighted average to acquire an average value according to the pixel value of the current pixel, the denoising weight of the current pixel, the pixel values of the adjacent pixels in the up, down, left and right sides, and the denoising weights of the adjacent pixels in the up, down, left and right sides, and use the average value to replace the pixel value of the current pixel.

The adaptive spatial-domain denoising module 704 further includes a weight calculation module 705, and the weight calculation module 705 is configured to calculate the denoising weight of the current pixel and the denoising weights of the adjacent pixels in the up, down, left and right sides, wherein the denoising weight of the current pixel is calculated according to a formula wₘ=x+y*L(i, j), x and y are empirical values, and regulated according to the denoising weight of the current pixel.

The weight calculation module 705 is further configured to calculate the denoising weights of the adjacent pixels in the up, down, left and right sides respectively according to the pixel value of the current pixel and the pixel values of the adjacent pixels in the up, down, left and right sides.

### APPLICATION EXAMPLE

The present invention will be further described in the embodiment with reference to a practical application scenario.

Firstly, the pixel value of each pixel at the same positions of a current frame and a previous adjacent frame thereof are acquired respectively. In the embodiment, it is provided that the current pixel value in the current frame is P(i, j)=50 and a normalized value is

$$V ( i , j ) = \frac{50}{255} \approx 0.196 ,$$

while the pixel value of the pixel at the same position of the previous adjacent frame thereof is P′(i, j)=60, and a normalized value is

$${V}^{′} ( i , j ) = \frac{60}{255} \approx 0.235 .$$

The noise intensity of the current pixel is calculated using the formula 1 according to the pixel value acquired. In the embodiment, it is preset that m=2 and n=0.9, then:

L(i, j)=(2*(1−|0.235−0.196|))hu 0.9*|0.235−0.196|≈0.070.

The pixel values of adjacent pixels in the up, down, left and right sides of the current pixel in the current frame are acquired respectively. In the embodiment, it is provided that the pixel values of the adjacent pixels in the up, down, left and right sides of the current pixel in the current frame are respectively as follows: P(i, j−1)=60, P(i, j+1)=60, P(i−1, j)=60 P(i+1, j)=60.

The denoising weight of the current pixel is calculated according to the formula 3. In the embodiment, the constant x=2, the constant y=6, and wₘ=2+6*L(i, j)=2+6*0.07=2.420.

The denoising weights of the adjacent pixels in the up, down, left and right sides are calculated according to the formula 5. In the embodiment, σ=15, and e=2.71828:

$${w}_{l} = {e}^{\{ \frac{- {[ P ( i - 1 , j ) - P ( i , j ) ]}^{2}}{2 {σ}^{2}} \}} = {e}^{\{ \frac{- {[ 60 - 50 ]}^{2}}{2 * {15}^{2}} \}} = {e}^{- 0.222} \approx 0.801$$

$${w}_{r} = {e}^{\{ \frac{- {[ P ( i + 1 , j ) - P ( i , j ) ]}^{2}}{2 {σ}^{2}} \}} = {e}^{\{ \frac{- {[ 60 - 50 ]}^{2}}{2 * {15}^{2}} \}} = {e}^{- 0.222} \approx 0.801$$

$${w}_{t} = {e}^{\{ \frac{- {[ P ( i , j - 1 ) - P ( i , j ) ]}^{2}}{2 {σ}^{2}} \}} = {e}^{\{ \frac{- {[ 60 - 50 ]}^{2}}{2 * {15}^{2}} \}} = {e}^{- 0.222} \approx 0.801$$

$${w}_{b} = {e}^{\{ \frac{- {[ P ( i , j + 1 ) - P ( i , j ) ]}^{2}}{2 {σ}^{2}} \}} = {e}^{\{ \frac{- {[ 60 - 50 ]}^{2}}{2 * {15}^{2}} \}} = {e}^{0.222} \approx 0.801$$

Weighted average is performed to acquire the average value according to the formula 6, and the average value is used to replace the pixel value of the current pixel:

N(i, j)=(50*2.420+60*0.801+60*0.801+60*0.801+60*0.801)/(2.420+0.801+0.801+0.801+0.801)≈56.

The 56 calculated out is used as a new pixel value to replace the pixel value of the current pixel acquired. Compared with the pixel value 50 before replacement, the pixel 56 acquired through denoising is closer to the pixel values of the adjacent pixels in the up, down, left and right sides of the current pixel in the current frame.

The device embodiments described above are only exemplary. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be finally noted that the above embodiments are only configured to explain the technical solutions of the present invention, but are not intended to limit the present invention. Although the present invention has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

### Fifth Embodiment

The present invention relates to a device for adaptive spatial-domain video denoising, comprising:

a processor; and

a memory adapted to store instructions which are executable by the processor;

wherein the processor is configured to:

acquire the pixel values of all the pixels at the same positions of a current frame and a previous adjacent frame thereof respectively and normalizing the pixel values acquired; calculate the noise intensity of a current pixel according to the pixel value of the current pixel in the current frame and the pixel value of the pixel in the previous adjacent frame at the same position with the current pixel after normalizing; acquire the pixel values of adjacent pixels in the up, down, left and right sides of the current pixel in the current frame respectively; and perform adaptive spatial-domain denoising on the current pixel according to the noise intensity, the pixel value of the current pixel and the pixel values of the adjacent pixels in the up, down, left and right sides.

In one embodiment, the processor is further configured to:

use a following formula L(i, j)=(m*(1−|V′(i, j)−V(i, j)|))ⁿ*|V′(i, j)−V(i, j)| to calculate the noise intensity of the current pixel, wherein V(i, j) is the pixel value of the current pixel after normalizing, V′(i, j) is the pixel value of the pixel in the previous adjacent frame at the same position with the current pixel after normalization, and m and n are constants, both of which are empirical values and preset according to the denoising intensity.

In one embodiment, the processor is further configured to:

weighted average is performed to acquire an average value according to the pixel value of the current pixel, the denoising weight of the current pixel, the pixel values of the adjacent pixels in the up, down, left and right sides, and the denoising weights of the adjacent pixels in the up, down, left and right sides, and the average value is used to replace the pixel value of the current pixel.

In one embodiment, the processor is further configured to:

the denoising weights of the adjacent pixels in the up, down, left and right sides are calculated using a formula

$${f}_{x} = {e}^{\{ \frac{- {x}^{2}}{2 {σ}^{2}} \}} ,$$

wherein the differences between the pixel values of the adjacent pixels in the up, down, left and right sides and the pixel value of the current are used as a random variable x, and σ is a preset standard deviation.

### INDUSTRIAL APPLICABILITY

The method and the device for adaptive spatial-domain video denoising provided by the present application can dynamically regulate the denoising intensity according to the noise intensity of each pixel in the video frame to finish denoising. For the video frame with noise intensity change or without noises, the present invention can adaptively determine through the noise intensity, thus avoiding detail losses caused to the video frames without noises while assuring the effective denoising on video frames having noises.

1. A method for adaptive spatial-domain video denoising, comprising:
acquiring the pixel values of all the pixels at the same positions of a current frame and a previous adjacent frame thereof respectively and normalizing the pixel values acquired;
calculating the noise intensity of a current pixel according to the pixel value of the current pixel in the current frame and the pixel value of the pixel in the previous adjacent frame at the same position with the current pixel after normalizing;
acquiring the pixel values of adjacent pixels in the up, down, left and right sides of the current pixel in the current frame respectively; and
performing adaptive spatial-domain denoising on the current pixel according to the noise intensity, the pixel value of the current pixel and the pixel values of the adjacent pixels in the up, down, left and right sides.

2. The method for adaptive spatial-domain video denoising according to claim 1, wherein the calculating the noise intensity of the current pixel further comprising:
using a following formula L(i, j)=(m*(1−|V′(i, j)−V(i, j)|))ⁿ*|V′(i, j)−V(i, j)| to calculate the noise intensity of the current pixel, wherein V(i, j) is the pixel value of the current pixel after normalizing, V′(i, j) is the pixel value of the pixel in the previous adjacent frame at the same position with the current pixel after normalization, and m and n are constants, both of which are empirical values and preset according to the denoising intensity.

3. The method for adaptive spatial-domain video denoising according to claim 1, wherein,
weighted average is performed to acquire an average value according to the pixel value of the current pixel, the denoising weight of the current pixel, the pixel values of the adjacent pixels in the up, down, left and right sides, and the denoising weights of the adjacent pixels in the up, down, left and right sides, and the average value is used to replace the pixel value of the current pixel.

4. The method for adaptive spatial-domain video denoising according to claim 3, wherein
The denoising weight of the current pixel is calculated according to a formula wₘ=x+y*L(i, j), wherein x and y are empirical values, and the denoising weight of the current pixel is decreased by decreasing x and decreasing y when the noise intensity L(i, j) is greater than a specific threshold.

5. The method for adaptive spatial-domain video denoising according to claim 3, wherein,
the denoising weights of the adjacent pixels in the up, down, left and right sides are calculated using a formula
$${f}_{x} = {e}^{\{ \frac{- {x}^{2}}{2 {σ}^{2}} \}} ,$$
wherein the differences between the pixel values of the adjacent pixels in the up, down, left and right sides and the pixel value of the current are used as a random variable x, and σ is a preset standard deviation.

6. A device for adaptive spatial-domain video denoising, comprising:
a processor; and
a memory adapted to store instructions which are executable by the processor;
wherein the processor is configured to:
acquire the pixel values of all the pixels at the same positions of a current frame and a previous adjacent frame thereof respectively and normalizing the pixel values acquired;
calculate the noise intensity of a current pixel according to the pixel value of the current pixel in the current frame and the pixel value of the pixel in the previous adjacent frame at the same position with the current pixel after normalizing; acquire the pixel values of adjacent pixels in the up, down, left and right sides of the current pixel in the current frame respectively; and perform adaptive spatial-domain denoising on the current pixel according to the noise intensity, the pixel value of the current pixel and the pixel values of the adjacent pixels in the up, down, left and right sides.

7. The device according to claim 6, wherein the processor is further configured to:
use a following formula L(i, j)=(m*(1−|V′(i, j)−V(i, j))ⁿ*|V′(i, j)−V(i, j)| to calculate the noise intensity of the current pixel, wherein V(i, j) is the pixel value of the current pixel after normalizing, V′(i, j) is the pixel value of the pixel in the previous adjacent frame at the same position with the current pixel after normalization, and m and n are constants, both of which are empirical values and preset according to the denoising intensity.

8. The device according to claim 6, wherein the processor is further configured to:
weighted average is performed to acquire an average value according to the pixel value of the current pixel, the denoising weight of the current pixel, the pixel values of the adjacent pixels in the up, down, left and right sides, and the denoising weights of the adjacent pixels in the up, down, left and right sides, and the average value is used to replace the pixel value of the current pixel.

9. The device according to claim 8, wherein the processor is further configured to:
The denoising weight of the current pixel is calculated according to a formula wₘ=x+y*L(i, j), wherein x and y are empirical values, and the denoising weight of the current pixel is decreased by decreasing x and decreasing y when the noise intensity L(i, j) is greater than a specific threshold.

10. The device according to claim 8, wherein the processor is further configured to:
the denoising weights of the adjacent pixels in the up, down, left and right sides are calculated using a formula
$${f}_{x} = {e}^{\{ \frac{- {x}^{2}}{2 {σ}^{2}} \}}$$
wherein the differences between the pixel values of the adjacent pixels in the up, down, left and right sides and the pixel value of the current are used as a random variable x, and σ is a preset standard deviation.
